(19) United States
(12) Patent Application Publication
(10) Pub. No.: US 2015/0016666 A1
(43) Pub. Date: Jan. 15, 2015

(54) Method and Apparatus for Determining Geolocation of Image Contents

(71) Applicant: Google Inc., (US)

(72) Inventor: Anthony Howard Payne, Jr., Northridge, CA (US)

(73) Assignee: Google Inc., Mountain View, CA (US)

(21) Appl. No.: 13/667,761

(22) Filed: Nov. 2, 2012

(51) Int. Cl. G06K 9/00

(52) U.S. Cl. CPC G06K 9/00
USPC 382/103

(57) ABSTRACT

A method and apparatus for determining a location of an object depicted in an image are disclosed. The location of an object depicted in an image is determined based on one or more of a camera location at a time the image was captured, object distance data, and camera orientation. Object distance data can include distance to subject data or focal length data. Camera orientation information can include azimuth and elevation angle which can be used to determine a direction from camera an object is located and an elevation of an object with respect to the camera. In one embodiment, image and object data are stored in a database which can be accessed by users to search for images and objects.

### BACKGROUND OF THE INVENTION

The present invention relates generally to location determination, and more particularly to determining the geolocation of objects in an image.

Cameras are often equipped with location determination hardware, such as a GPS receiver, which can determine the location of a camera. After an image is captured, information concerning the location of the camera at the time the image was captured can be stored with image data, allowing a user to know the location of the camera when the image was captured.

### BRIEF SUMMARY OF THE INVENTION

Although cameras with location determination hardware can produce image data including location information for association with images, the location information indicates the location of the camera and not the location of objects in an image.

In one embodiment, a method for determining a location of an object depicted in an image begins with receiving camera location data and object distance data associated with an image. The location of the object depicted in the image is determined based on the camera location and object distance data. In one embodiment, camera orientation data is also received and the location of the object is additionally based on the orientation data. Camera orientation data can include a direction the camera is pointing when the image is captured (i.e., azimuth) and an angle from horizontal the camera is pointing (i.e., elevation angle). The distance of the object from the camera is determined, in one embodiment, based on distance to subject data and, in another embodiment, based on focal length data. The direction of the object with respect to the camera is determined, in one embodiment, based on camera orientation data.

An apparatus for determining the location of an object depicted in an image is also disclosed.

These and other advantages of the invention will be apparent to those of ordinary skill in the art by reference to the following detailed description and the accompanying drawings.

### BRIEF DESCRIPTION OF THE DRAWINGS

FIG. 1A shows a schematic of a camera connected via a network to devices used to store and analyze images according to one embodiment;

FIG. 1B illustrates a relationship between focal length and a distance between a lens and an object the lens is focused on according to one embodiment;

FIG. 2 depicts an image data table containing information pertaining to captured images according to one embodiment;

FIG. 3 depicts a flow chart of a method for determining the location of objects depicted in an image according to one embodiment;

FIG. 4 depicts a flow chart which details one of the steps of the flowchart depicted in FIG. 3 according to one embodiment;

FIG. 5 depicts how data identifying a distance of an object from a camera identifies a location of the object on the circumference of a circle having a radius equal to the distance and centered on the camera location according to one embodiment;

FIG. 6 depicts the relationship between the distance an object is located from a camera, an elevation angle of the camera, and the horizontal and vertical displacement of the object from the camera according to one embodiment;

FIG. 7 depicts an object data table containing information pertaining to objects identified in captured images according to one embodiment; and

FIG. 8 depicts a high-level block diagram of an exemplary computer according to one embodiment that may be used to implement various systems, apparatus and methods described herein.

### DETAILED DESCRIPTION

The present disclosure pertains to a method and apparatus in which images captured using a device, such as a digital camera, are analyzed to determine the location of objects depicted in the image. In contrast, data typically associated with an image pertains only to the location of the image capturing device (e.g., camera) at the time the image was taken and not the location of objects in the image. The location of an object depicted in an image, according to one embodiment, is determined based on a location of the camera used to capture the image at the time the image was captured, object distance data, and camera orientation data.

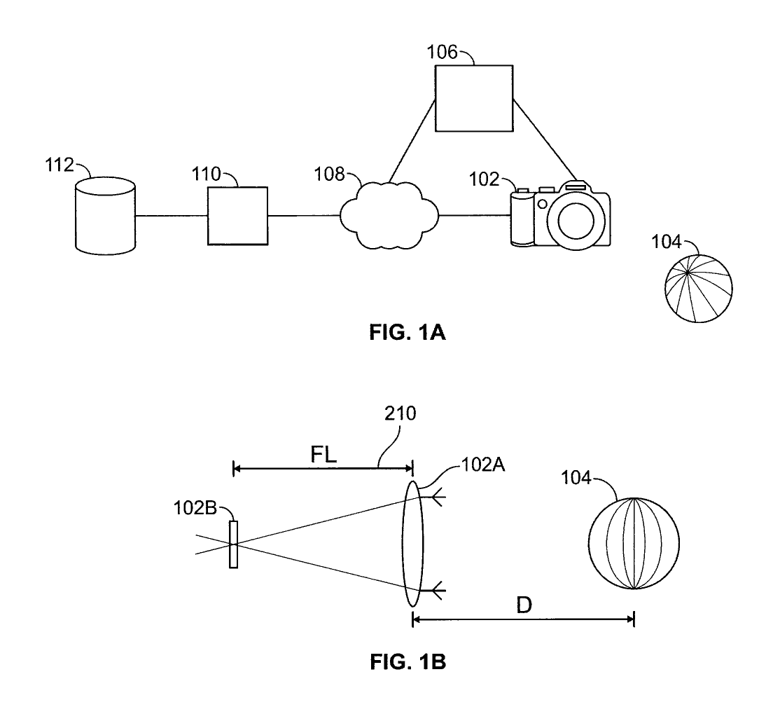

FIG. 1A shows a schematic of a camera 102 used to capture images (also referred to as taking a picture). Camera 102 includes hardware for capturing images such as a lens and a sensor for converting light into signals such as a charge-coupled device (CCD) or complementary metal-oxide-semiconductor (CMOS). Camera 102 can also include additional hardware to assist in capturing images such as a range finder for determining a distance from camera 102 to an object of interest, such as ball 104. Camera 102 can be equipped with additional hardware for determining the location of the camera. For example, a camera may be equipped with a global positioning system (GPS) receiver or other hardware for determining the location of the camera. In one embodiment, a GPS receiver external to the camera (not shown) may be used to determine a location of the camera at the time an image was captured. A time an image was acquired may be used to determine a location of the camera at a corresponding time using location information gathered by the external GPS receiver.

Camera 102 can be used to take a picture of object 104, in this case, a beach ball. After an image of the beach ball is taken, it is saved in a memory of camera 102. A captured image is stored in camera memory with associated image data.

Images can be generated and stored in various formats such as JPEG (Joint Photographic Experts Group), TIFF(Tagged Image File Format), and raw image format. Image data (also referred to as image metadata) contains information about an image and can be stored in a specific format (e.g., EXIF (Exchangeable Image File Format)).

Images taken using camera 102, together with associated image data, can be uploaded to a device such as computer 106. Alternatively, images may be uploaded to another device, such as image server 110, via network 108. Image server 110, in one embodiment, is in communication with image database 112 which may be used to store images and associated image data.

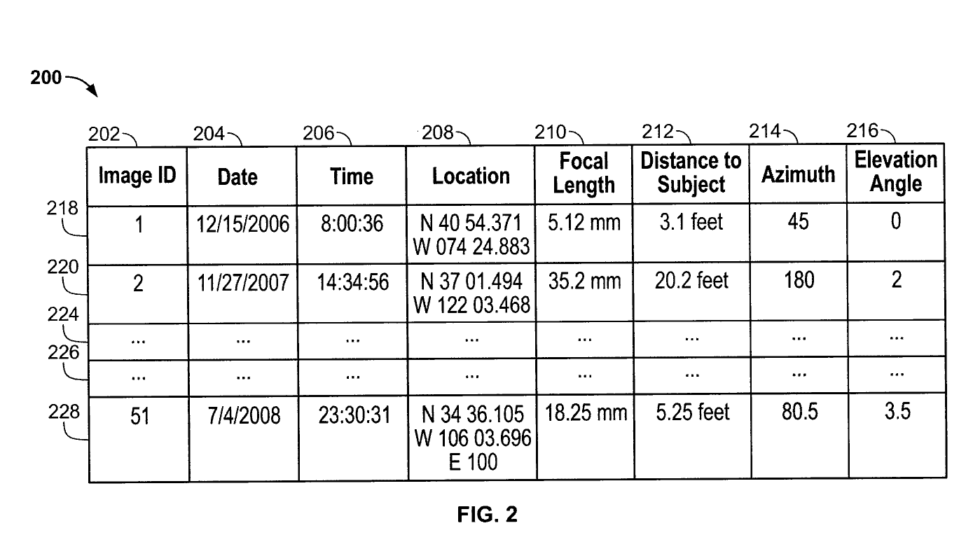

FIG. 2 depicts an image data table 200 which includes multiple records 218-228 containing image data 204-216 associated with an image identified by image ID 202. Image ID 202 uniquely identifies a particular image taken on a particular date 204 at a particular time 206. Additional image data including location 208, focal length 210, distance to subject 212, azimuth 214, and elevation angle 216 are also stored in records 218-228 of table 200.

Image data may be obtained using various hardware. For example, location 208 identifies the location of camera 102 when an image is taken and, in one embodiment, is obtained using a GPS receiver built into camera 102. Location information can alternatively be determined using other types of hardware for determining location. Location information can be stored in location 208 in various formats. As shown in FIG. 2, location 208 of record 218 is stored in a longitude/latitude format in which displacement from a reference point is described in terms of north and west. The format of the information stored in location 208 generally depends on the type of location determining hardware of camera 102. In one embodiment, location information includes elevation above sea level for a particular location. For example, location 208 of record 228 includes “E 100” which indicates that the location is 100 feet above sea level. Although elevation in this example is provided with respect to sea level, any point of reference may be used.

Focal length 210 indicates the focal length of the camera optics at the time an image was captured. FIG. 1B illustrates a configuration of lens 102A and image sensor 102B according to one embodiment in which focal length 210 is a distance from the centerline of lens 102A to the face of image sensor 102B both of which are part of camera 102. In one embodiment, lens 102A is moveable with respect to image sensor 102B in order to focus an image of object 104 on the surface of image sensor 102B. Focal length 210 can be used in conjunction with additional information (e.g., data pertaining to where focus has been set) to determine a distance “D” from the camera (more specifically, lens 102A) at which objects will be in focus. Since the object of interest in an image is generally also the object to which the camera optics are focused, focal length 210 and data pertaining to where focus has been set can be used to determine a distance “D” an object is located from camera 102 when an image is captured.

Information concerning focal length, in one embodiment, is determined by camera hardware. In one embodiment, a camera has a non-removable lens and focal length is determined based on orientation of the camera optics (i.e., where the focus has been set). For example, the distance between the lens and image sensor of the camera. In one embodiment, camera 102 can be equipped with one of several different lenses. In this embodiment, the particular lens attached to camera 102 may be automatically determined by camera 102 or manually entered by a user.

Returning to FIG. 2, distance to subject 212 indicates the distance an object of interest is located from camera 102. In one embodiment, distance to subject information is obtained using hardware, such as a distance encoder, included with a camera. A distance encoder is a lens component that directly detects the position of the focusing mechanism, and sends a signal to a CPU of the camera in order to measure distance to the subject. During flash photography, this data is very useful in calculating how much flash output is appropriate to the scene.

Distance to subject 212 can also be obtained using other hardware included in camera 102 such as an infrared based or sound based range sensor included in many cameras for autofocus. Distance to subject 212 may also be calculated based on focal length information together with optics information pertaining to the particular camera used, image sensor size information, where the focus is set, etc. In one embodiment, data from an EXIF file associated with an image (i.e., distance to subject information) can be used to populate distance to subject 212.

Azimuth 214 indicates an angular orientation of camera 102 with respect to a reference. Azimuth 214 indicates an angular orientation of camera 102 with respect to north, which in this embodiment, is represented by zero. In one embodiment, azimuth 214 is determined by camera hardware such as a solid state compass. Alternatively, azimuth 214 can be determined using a GPS receiver alone or in conjunction with accelerometers. Elevation angle 216 (also known as altitude) indicates the orientation of camera 102 with respect to horizontal. Elevation angle 216 shown in FIG. 2 indicates the elevation angle of camera 102 in degrees with respect to horizontal, which in this embodiment, is represented by zero. In one embodiment, hardware contained in camera 102, such as an accelerometer, is used to determine elevation angle 216.

It should be noted that values for image data 204-216 associated with a particular image ID 202 pertain to camera location and orientation at the time the image identified by image ID 202 was taken.

Images and image data stored on camera 102 can be uploaded to computer 106 via a wired connector (e.g., USB) or wirelessly. Images and image data stored on camera 102 can alternatively be uploaded in a similar manner to image server 110 via network 108. In addition, images and image data can be transferred from computer 106 to image server 110 via network 108.

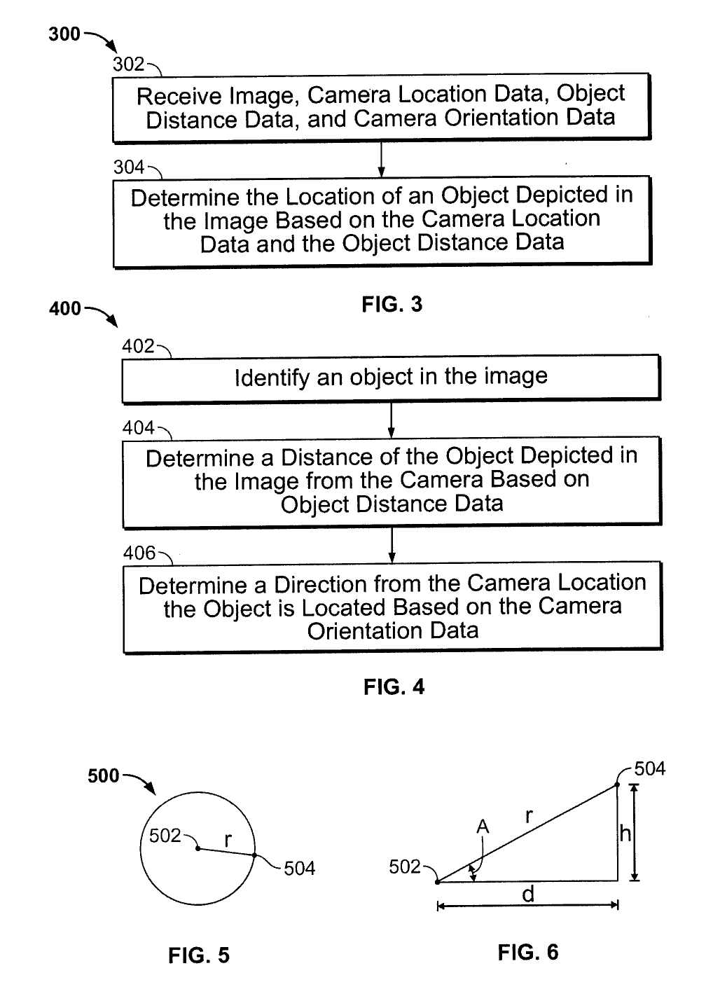

Images and image data uploaded to computer 106 or image server 110, in one embodiment, are analyzed to determine the location of objects in images. FIG. 3 depicts flow chart 300 of a method for determining the location of objects in images according to one embodiment. At step 302, an image, camera location data, object distance data, and camera orientation data is received, at computer 106. At step 304, the location of an object depicted in the image is determined by computer 106 based on the camera location and the object distance data. This method is described further in conjunction with FIG. 4.

FIG. 4 depicts flow chart 400 which details step 304 of FIG. 3. At step 402, an object in the image is identified. In one embodiment, the object in the image is identified by analyzing the image using one or more techniques such as edge detection, recognition by parts, edge matching, or pattern matching. In one embodiment, bounding boxes for each of the recognized objects are identified. A bounding box can then be projected on a field of view to determine a position of an object more specifically. In one embodiment, an object database contains information about a physical size of recognized objects. For example, a person may be known to be a specific height. This information can be used to determine a distance of that person from the camera using the corresponding bounding box. At step 404, a distance of the object depicted in the image from the camera is determined based on object distance data. In one embodiment, focal length 210 shown in FIG. 2 is used to calculate the distance an object is located from the camera. Various formulas can be used to determine the distance of an object from the camera based on focal length 210.

In an alternative embodiment, distance to subject 212 can be used to determine the distance an object depicted in the image is located from camera 102. Distance to subject 212, as described above, can be acquired, in one embodiment, using a distance encoder. In other embodiments, range sensors using acoustic or infrared signals can be used to determine the distance of objects from camera 102. For example, in acoustic range sensors an acoustic emitter emits sound waves which travel to an object at which the camera is pointed. The object reflects the sound waves, some of which travel back toward the camera and are received by the acoustic receiver. The time it takes for the sound waves to travel from the camera to the object and return to the camera is used to calculate the distance of the object from the camera. Infrared range sensors operate in a similar manner. As such, in contrast to focal length 210, distance to subject 212 typically provides an actual distance of an object depicted in an image from camera 102 and the calculations required to determine an object's distance from camera 102 using focal length are not needed.

Although the distance of an object from the camera is determined in step 404, determining the actual location (e.g., geographic coordinates) of the object requires additional information. As such, as shown in FIG. 5, the determined distance only indicates that the object is located at some point along the circumference of a circle 500 centered on a location of the camera 502 and having a radius r equal to the determined distance.

At step 406, a direction from the camera location the object is located is determined based on the camera orientation data. Azimuth 214 indicates a direction in which the camera is pointed when the related image was taken. Azimuth 214, indicates an angle from a particular reference angle. In one embodiment, north is designated zero and angles from north are measured in increasing degrees clockwise from north. For example, zero degrees designates north, ninety degrees designates east, one-hundred eighty degrees designates south, and two-hundred seventy degrees designates west. The accuracy of a particular angle can be designated with a specific granularity. For example, in one embodiment, portions of a degree could be indicated in decimal or using minutes and seconds in addition to degrees.

Determining a location of an object in an image using a location of camera 102, object identification, focal length, and azimuth provides object location information with an accuracy suitable for many uses. However, greater accuracy of a location of an object can be determined by taking into account an elevation angle of camera 102 when an image is taken. For example, a distance between the camera and an object may be determined to be 20 meters. If the image is taken when the camera is horizontal, then the object is 20 meters away from the camera in a determined direction. However, if the camera is tilted up or down, the distance of the object from the camera is a combination of a horizontal displacement and a vertical displacement above or below the camera. If the tilt of the camera (i.e., the elevation angle) and the distance between the object and the camera is known, the vertical and horizontal displacement of the object from the camera can be determined.

FIG. 6 depicts a relationship among a distance r of object 504 from camera 502, a distance d between camera 502 and object 504 along a horizontal plane (i.e., horizontal displacement), a height h of object 504 above the horizontal plane in which camera 502 is located (i.e., vertical displacement), and angle A which is elevation angle 216 of FIG. 2. Since the distance r and the angle A are known, height h and distance d can be calculated. Distance d and height h can then be used to more accurately determine the location of object 504 previously determined using camera location, focal length or range, and azimuth. For example, if height h for a particular object is determined to be 50 feet, then 50 feet would be added to the elevation of camera 102 to produce an elevation of the object since the object is determined to be 50 feet above the elevation of camera 102. The result of the above described calculations can then be stored in a table.

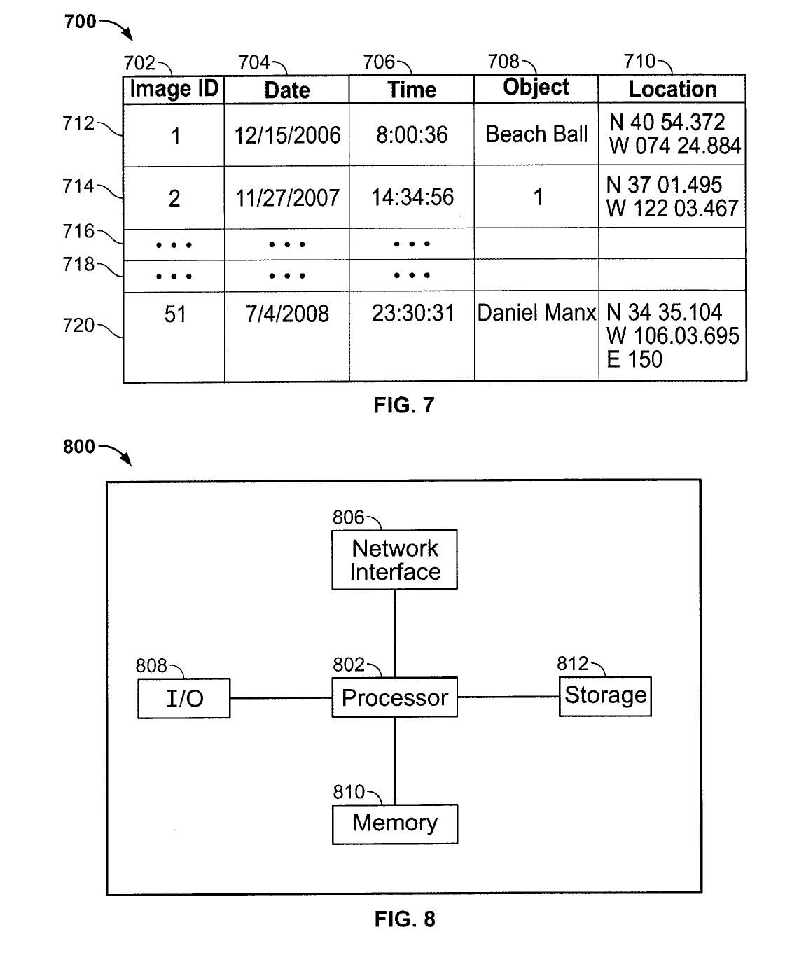

FIG. 7 depicts object location table 700 which includes multiple records 712-720 containing object data 704-710 associated with an object depicted in an image identified by image ID 702. It should be noted that image ID 702 of FIG. 7 corresponds to image ID 202 of FIG. 2. Date 704 and time 706 FIG. 7 correspond to date 204 and time 206 of FIG. 2 since an object captured in an image has the same date and time as the image containing the object. Object 708 contains an identification of a particular object in an image. In one embodiment an object in an image may be identified using object recognition and object 708 contains a description of the identified object. For example, object 708 of record 712 identifies an object in image 1 as a beach ball. In another embodiment, an object may be identified by a number, for example, object 708 of record 714 is identified as number “1”. In embodiments in which objects are identified by a number, each object in a particular image is provided with a unique number. In one embodiment, each object is provided with a unique identification number that may be used with different images. For example, a particular person may be designated by a unique identification number. This allows images depicting a particular person to be identified using the unique identification number associated with the particular person. Location 710 contains a location of an object identified in object column 708 determined as described above. In one embodiment, a location of an object is provided using longitude and latitude. In some embodiments, an elevation of an object is provided as well. For example, the elevation of location 710 in record 720 is identified as “E 150” which, in this case, indicates that the object is location 150 feet above sea level.

In one embodiment, image data table 200 and object data table 700 are stored in image database 112. Information stored in image database 112 can be accessed from computer 106 via network 108 and image server 110. In another embodiment, portions of image data table 200 and object data table 700 may be stored in computer 106. For example, a particular user's images and image data may be stored on computer 106 which allows a user to locally access images and image data. Access to tables 200 and 700 allow a user to search for images based on any of particular entry. For example, a user may search for images containing objects located within a specific distance/radius from a particular location.

It should be noted that, although the methods of FIGS. 3 and 4 are described as being performed by computer 106, those methods may alternatively be performed by image server 110. In one embodiment, image server 110 receives information as described in step 302. Generally an image and related image data are received by computer 106 or image server 110 from camera 102. However, images and image data can be received from devices other than camera 102. For example, images and image data can be acquired by computer 106 or image server 110 via email or file transfer. In one embodiment, images and image data can be received from another device such as another computer, or a portable storage medium/device such as a compact disc or flash drive.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 3 and 4. Certain steps of the methods described herein, including one or more of the steps of FIGS. 3 and 4, may be performed by a server or by another processor in a network-based cloud-computing system. Certain steps of the methods described herein, including one or more of the steps of FIGS. 3 and 4, may be performed by a client computer in a network-based cloud computing system. The steps of the methods described herein, including one or more of the steps of FIGS. 3 and 4, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 3 and 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus, and methods described herein is depicted in FIG. 8. Computer 800 includes a processor 802 operatively coupled to a data storage device 812 and a memory 810. Processor 802 controls the overall operation of computer 800 by executing computer program instructions that define such operations. The computer program instructions may be stored in data storage device 812, or other computer readable medium, and loaded into memory 810 when execution of the computer program instructions is desired. Thus, the method steps of FIGS. 3 and 4 can be defined by the computer program instructions stored in memory 810 and/or data storage device 812 and controlled by processor 802 executing the computer program instructions. For example, the computer program instructions can be implemented as computer executable code programmed by one skilled in the art to perform an algorithm defined by the method steps of FIGS. 3 and 4. Accordingly, by executing the computer program instructions, the processor 802 executes an algorithm defined by the method steps of FIGS. 3 and 4. Computer 800 also includes one or more network interfaces 806 for communicating with other devices via a network. Computer 800 also includes one or more input/output devices 808 that enable user interaction with computer 800 (e.g., display, keyboard, mouse, speakers, buttons, etc.).

Processor 802 may include both general and special purpose microprocessors, and may be the sole processor or one of multiple processors of computer 800. Processor 802 may include one or more central processing units (CPUs), for example. Processor 802, data storage device 812, and/or memory 810 may include, be supplemented by, or incorporated in, one or more application-specific integrated circuits (ASICs) and/or one or more field programmable gate arrays (FPGAs).

Data storage device 812 and memory 810 each include a tangible non-transitory computer readable storage medium. Data storage device 812, and memory 810, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 808 may include peripherals, such as a printer, scanner, display screen, etc. For example, input/output devices 808 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including camera 102, computer 106, image server 110, and database 112, may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining a location of an object depicted in an image comprising:
receiving camera location data, distance to subject data, camera direction data and camera elevation angle data associated with an image; and
determining the location of an object depicted in the image based on the camera location data, distance to subject data, camera direction data, and camera elevation angle data.

2. A method for determining a location of an object depicted in an image comprising:
receiving camera location data and object distance data associated with an image; and
determining the location of an object depicted in the image based on the camera location data and the object distance data.

3. The method of claim 2 wherein the object distance data comprises distance to subject data.

4. The method of claim 2 wherein the object distance data comprises focal length data.

5. The method of claim 3 further comprising:
receiving camera orientation data,
wherein the determining is further based on the camera orientation data.

6. The method of claim 5 wherein the camera orientation data comprises a direction the camera is pointing when the image was acquired.

7. The method of claim 6 wherein the camera orientation data comprises an elevation angle of the camera when the image was acquired.

8. The method of claim 7 wherein the determining the location further comprises:
determining a direction from a camera location that the object is located based on the camera orientation data.

9. The method of claim 4 further comprising:
receiving camera orientation data,
wherein the determining is further based on the camera orientation data.

10. The method of claim 9 wherein the camera orientation data comprises a direction the camera is pointing when the image was acquired.

11. The method of claim 10 wherein the camera orientation data comprises an elevation angle of the camera when the image was acquired.

12. The method of claim 11 wherein the determining the location further comprises:
determining a direction from a camera location that the object is located based on the camera orientation data.

13. An apparatus for determining a location of an object depicted in an image, the apparatus comprising:
means for receiving camera location data and object distance data associated with an image; and
means for determining the location of an object depicted in the image based on the camera location data and the object distance data.

14. The apparatus of claim 13 wherein the object distance data comprises distance to subject data.

15. The apparatus of claim 13 wherein the object distance data comprises focal length data.

16. The apparatus of claim 14 further comprising:
means for receiving camera orientation data,
wherein the determining is further based on the camera orientation data.

17. The apparatus of claim 16 wherein the camera orientation data comprises a direction the camera is pointing when the image was acquired.

18. The apparatus of claim 17 wherein the camera orientation data comprises an elevation angle of the camera when the image was acquired.

19. The apparatus of claim 18 wherein the means for determining the location further comprises:
means for determining a direction from a camera location that the object is located based on the camera orientation data.

20. The apparatus of claim 15 further comprising:
means for receiving camera orientation data,
wherein the determining is further based on the camera orientation data.
